(19) United States
(12) Patent Application Publication
(10) Pub. No.: US 2007/0234843 A1
(43) Pub. Date: Oct. 11, 2007

(54) Method and device for selecting driving programs in automatic transmissions

(76) Inventor: Ingolf Knabe, Koln (DE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/697,095

(22) Filed: Apr. 5, 2007

(30) Foreign Application Priority Data
Apr. 10, 2006 (DE) 102006016780.5

(51) Int. Cl. G05G 1/04

(52) U.S. Cl. 74/523

(57) ABSTRACT

Method and device for selecting a driving program in motor vehicles having an automatic transmission, in which at least two different driving programs, in particular an economy mode and a sport mode, can be selected by the driver. The driving program selection according to the invention is made here by briefly tipping the selector lever laterally and releasing it again.

For this purpose, the selector lever is pressed briefly to the side counter to a spring force, i.e. transversely with respect to the direction of movement within the shifting gate alley, suitable means, such as position sensors or force sensors, respectively generating corresponding signals both when the selector lever is tipped and when it is released again, and said signals are analyzed in a control unit such as the transmission controller or a central vehicle electronic system in terms of their time interval, and as a result trigger a driving program changeover by means of the control unit. The respectively active driving program can be displayed here, for example, by means of a display on the dashboard. Since the driving program changeover is carried out only by tipping the selector lever laterally, the driver does not need to look at any operator control or operator control position in this context and is thus not distracted in any way from driving and observing the traffic situation.

### FIELD OF THE INVENTION

The invention relates, according to the preamble of patent claim 1, to a method for selecting driving programs in motor vehicles having an automatic transmission, with the possibility of at least two different driving programs, in particular an economy program and a sport program, being selected by the driver. According to the preamble of patent claim 8, the invention also relates to a device for carrying out the method.

### BACKGROUND

Automatic transmissions are often operated by means of a selector lever in the center console which lever is guided in a shifting gate and permits operating states to be selected such as parking brake, idling, reverse travel, normal travel mode and limitation of the maximum gear, for example for traveling downhill. To an increasing degree, in automatic transmissions the driver is also provided with the possibility of quasi-manual gear change. The operator control for this is carried out, for example, by means of a rocker switch on the steering wheel or a second shifting gate of the selector lever.

Driving programs in motor vehicles with an automatic transmission in the automatic mode are usually selected by means of a rocker switch, for example on the center console or on the steering wheel or by means of push button keys on the selector lever or by means of the selector lever itself, and said selection brings about gear shifting processes at different rotational speeds, inter alia by influencing the transmission operator control field, so that, for example in the economy program, the shifting up into a higher gear speed takes place earlier in order to bring about relatively low engine speeds and thus lower fuel consumption, and analogously the shifting down into a lower gear speed does not take place until a later time, while in the sport program the shifting up into a higher gear speed does not take place until a later time for the sake of better acceleration behavior of the motor vehicle, while accepting higher fuel consumption. It is also known that the engine management system can be influenced, for example, by changing the injection pump characteristic diagram by means of the respective driving program selection.

For this purpose, the different driving programs are usually stored in an electronic control unit of the automatic transmission and/or of the electronic control system of the motor vehicle, adaptive solutions also being known in which the program sequences of the different driving programs can be adapted automatically to the respective driver by analyzing the driving behavior or by a driver code input. Systems are also known which have more than two driving programs, for example for more finely graduated adaptation of the driving dynamics but also in order to implement special modes such as a winter setting for transmitting force to the road with as little torque as possible.

DE 37 17 675 thus discloses a corresponding device for selecting driving programs in motor vehicles having an automatic transmission, in which a push button shift, with which it is possible to make a selection between an economy program and a sport program in the automatic program mode is arranged on the selector lever. The disadvantages of this solution are that an additional shift device which entails costs is necessary here, and the driver is distracted from the traffic events by his operation of the various operator control elements.

EP 685 664 discloses a shifting device in which the selection of the driving programs is made by positioning the selector lever within an H shaped shifting gate (consumption oriented driving program in the region of the automatic shifting gate and a sporty driving program in the region of the manual shifting gate alley) the respective driving program being activated after a defined time interval has been reached. The shifting over to another driving program is therefore disadvantageously delayed here. A further disadvantage is that the driver is also distracted from the traffic events here since he has to concentrate on the precise position of the selector lever during the selection of the driving program.

This problem also occurs in the solution presented in EP 780 600. Here, the shifting over to the sport program is carried out by pivoting the selector lever in the transverse alley with respect to the shifting gate alley for the manual shifting mode so that the driver is also distracted here from the traffic events by his concentration on a defined selector lever position. Furthermore, during the attempt to shift to the sport program the driver can easily inadvertently leave the automatic mode entirely as a result of an additional selector lever movement as he pivots the selector lever. Furthermore, it is disadvantageous that although the driver pivots the selector lever into the manual shifting gate alley, an automatic mode is still activated and the driver does not enter the manual mode until he makes an additional selector lever movement. In the process, it is possible to select a different gear speed which was, however, entirely unintended by the driver.

In DE 199 41 013 the gear speed changing key on the steering wheel is used to change the driving program in the automatic mode, thus avoiding the driver being distracted from the traffic events, but the disadvantage here is the need for an additional shifting device, the gear speed changing key on the steering wheel, which entails costs.

### SUMMARY OF THE INVENTION

The object of the invention is therefore to make available a method and a device for carrying it out which permits the driving program to be changed quickly and reliably, for example during overtaking processes, while avoiding the disadvantages occurring in the prior art, in which case, in particular, the driver is not distracted from controlling the vehicle or observing the traffic as he changes the driving program. Furthermore, the object of the invention is to make the device as structurally simple as possible and thus save costs, in particular avoiding operator controls other than the selector lever. Furthermore, the possibility of the automatic mode and manual mode being mistaken for one another in selector devices which have these two modes is to be avoided by virtue of the fact that in the automatic mode the selector lever is always in the automatic alley, and in the manual mode it is always in the manual alley.

The driving program selection according to the invention in motor vehicles having an automatic transmission is carried out by brief, lateral to and fro movement of the selector lever, with suitable means respectively generating corresponding signals for the to and fro movement, and the changeover in the driving program being triggered when time intervals between the two signals drop below and/or exceed defined values. The lateral movement transversely with respect to the main activation direction of the selector lever is not to be understood solely as a right-angled movement with respect to the shifting gate alley here but rather this transverse movement can also take place at a certain angle with respect to the shifting gate alley, that is to say does not need to be entirely at right angles to the shifting gate alley. This is also the case if the shifting gate alley is not straight but rather forms a maze. The driver simply has to be able to change the driving program by means of a selective and intentional transverse movement of the selector lever.

A driving program changeover is triggered only if the to and fro movement of the selector lever takes place within a defined time interval between the two signals. In one embodiment of the invention, the time interval should not exceed a specific time. The time interval is advantageously less than 2 seconds and particularly advantageously less than 1 second. This means that the to and fro movement must not last longer than 2 seconds or 1 second. If it lasts longer, there is no changeover of the driving program. The time interval can, however, also be longer than a specific time period, here 0.1 seconds and advantageously longer than 0.5 seconds. So the to and fro movement must last at least 0.1 seconds or 0.5 seconds, or otherwise the driving program is not changed over.

Finally, a mixture of the two criteria is also possible. The time interval must then have a minimum time period, but must not exceed a maximum time period. This means, for example, the to and fro movement must last at least 0.2 second and can last 1.5 seconds at maximum for the changeover of the driving program to be carried out. This method ensures that a driver's request to change over the driving program is recognized as such and the driver intentionally carries out the to and fro movement of the selector lever.

Random to and fro movements of the selector lever because, for example, the driver or passengers inadvertently move the selector lever, then do not bring about a changeover of the driving program.

In the method, it is also possible to select two driving programs by virtue of the fact that a to and fro movement of the selector lever to one side triggers a first driving program, and a to and fro movement of the selector lever to the other side triggers a second driving program. This is to be understood as meaning that in order to shift the first driving program the lever is moved in a transverse direction with respect to the shifting gate alley, and in order to shift the second driving program the to movement in the opposite direction transversely with respect to the shifting gate alley takes place. As a result, the driver can unambiguously activate a driving program without having knowledge of the current driving program.

The method can also be embodied in such a way that at least two driving programs can be selected by virtue of the fact that the selector lever is moved repeatedly to and fro in succession, and the number of to and fro movements determines the driving program to be selected. As a result, a specific number of driving programs can be run through until the original driving program is selected again.

The lateral to and fro movement is advantageously carried out by tipping the selector lever counter to a spring force and releasing it again. For this purpose the selector lever is briefly pressed to the side counter to a spring force, i.e. transversely with respect to the direction of movement within the shifting gate alley, suitable means such as position sensors respectively generating corresponding signals both when the selector lever leaves the position of rest (selector lever position “D” in the automatic mode) and returns to it, said signals being analyzed in a control unit such as the transmission controller or a central vehicle electronic system with respect to their time interval and consequently triggering a changeover of the driving program by means of the control unit.

A further embodiment of the invention provides for the selector lever to be moved into a latched position between the to movement and the fro movement. This latched position can be provided in the movement path of the selector lever. However, the latched position can also be a different shifted position of the selector lever, for example the shifted positions for the manual mode in a shifting device which has a corresponding shifting alley between the automatic mode and manual mode.

The methods can advantageously be combined with spring loading and a latched position by virtue of the fact that by tipping the selector lever counter to a spring load a first driving program is triggered and a second driving program is triggered by the to and fro movement of the selector lever into a latched position.

The inventive device for selecting at least two different driving programs in motor vehicles having an automatic transmission comprises an automatic transmission selector lever which is guided in a shifting gate alley, means for generating electrical signals during every lateral to and fro movement of the selector lever, and a control device which triggers a driving program changeover when the time interval between the signals generated during the to and fro movement drops below a defined value. This device advantageously permits one of the methods described above to be carried out.

In one embodiment of the device, the electrical signal for changing over the driving program is generated by tipping in the transverse direction laterally, i.e. with respect to the direction of movement within the shifting gate alley, and releasing the selector lever again counter to a spring force, the control unit not triggering a driving program changeover until the spring force exceeds a defined value, the two signals occur with a defined time interval when the selector lever is tipped and released again, and the selector lever is in the automatic mode, in particular in the position D. The spring force provides the driver with feedback that the selector lever has been correctly activated. Instead of the defined spring force it is also possible to use a specific pivoting path of the selector lever as a criterion. The driver then knows that when there is a specific travel of the selector lever which the latter undergoes during the to movement the selector lever has been correctly activated.

A further embodiment of the invention provides that the electrical signal for changing over the driving program is triggered by a lateral to movement to a latching position and a subsequent fro movement of the selector lever, the control unit not triggering a driving program changeover until the reaching of the latched position has been detected by suitable means, the to and fro movement of the selector lever occurs in a defined time interval, and the selector lever is in the automatic mode, in particular in the position D. In this embodiment, it is possible for a latched position of a further shifted position which is present in any case at the device to be used to generate the signals, for example the shifted positions for the manual mode in a shifting device which has a corresponding shifting alley between automatic mode and manual mode.

The shifting gate of the automatic transmission shifting device advantageously has a shifting gate alley in which the selector lever can assume at least the shifted positions P, R, N and D. Furthermore, it is advantageous if the shifting gate additionally has a shifting gate alley for the manual gear change mode, in which alley the selector lever can assume the shifted positions for the manual gear change mode, for shifting up and for shifting down. The shifting gate can additionally have a shifting gate transverse alley for changing between the shifting gate alleys for the automatic mode and those for the manual gear change mode.

In a further embodiment, more than two driving programs can be selected by virtue of the fact that the selector lever is moved to and fro to the left and/or to the right. The selector lever then merely has to have corresponding degrees of freedom in both lateral directions of movement.

The respectively active driving program can be displayed here, for example, by means of the display on the dashboard. Since the changeover of the driving program is carried out only by laterally tipping the selector lever, the driver does not need to see any operator control or operator control position here and is thus not distracted in any way from driving and observing the traffic situation. The present invention can be used in automatic transmission shifting operations with one or more shifting gate alleys, that is to say even with selector levers with, for example, one automatic gate alley and one manual gate alley.

These properties which are very advantageous within the sense of the invention have the result that, in contrast to the prior art, with the method and device which are made available it is possible to carry out a driving program selection, for example during overtaking procedures, in a more cost effective and structurally easier way in motor vehicles with an automatic transmission without distracting the driver's attention from the traffic events. As a result, the objects on which the invention is based are completely achieved by the method which is made available and by the device which is made available for carrying out the method.

### BRIEF DESCRIPTION OF THE DRAWINGS

Two preferred exemplary embodiments of the device according to the invention are explained below with reference to the appended drawings, in which:

FIG. 1 is a schematic illustration of a shifting device according to the invention with just one shifting gate alley, and

FIG. 2 is a schematic illustration of a shifting device according to the invention with two shifting gate alleys for operating a motor vehicle automatic transmission either in automatic mode or in a mode for a manual gear change.

### DETAILED DESCRIPTION

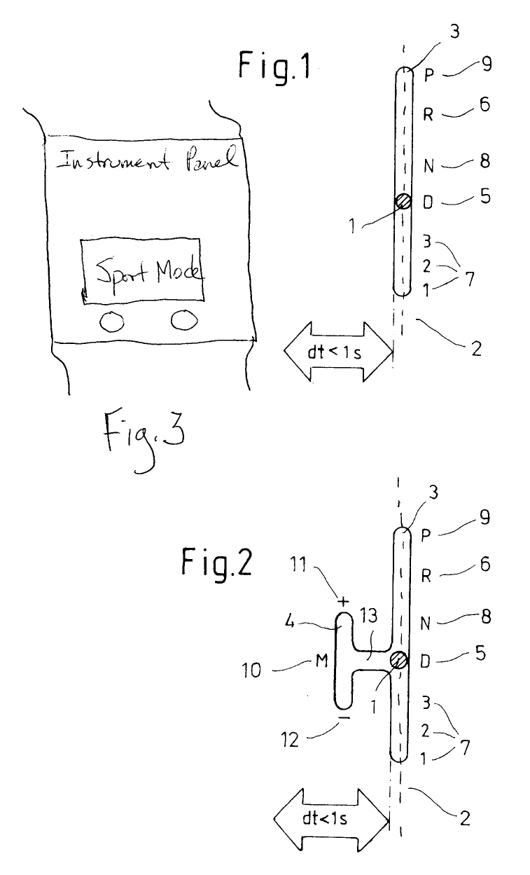

FIG. 1 shows a shifting gate 3 only for the automatic mode with a sectioned selector lever 1 in the interior of a motor vehicle, in particular on the center console. The selector lever 1 is mounted so as to be pivotable about its pivot point. The customary arrangement of the individual selector lever shifted positions for the assigned automatic transmission programs “P” 9, “R” 6, “N” 8, “D” 5, the programs for limiting the maximum gear 7 for, for example, traveling downhill “3”, “2”, “1” can be seen in the shifting gate. The driving program can be switched over, for example from the economy program into the sport program during an overtaking process from the gear lever shifted position “D” 5 by tipping the selector lever 1 to the left and releasing it again. In the process, a sensor senses the tipping and releasing of the selector lever 1, and the control signals which are generated in the process are passed on to an electronic control device which controls the automatic transmission. The control unit does not trigger a changeover of the driving program until the spring force in a force sensor or the pivoting path of the selector lever 1 exceeds a defined value at a position sensor, and the two signals during the tipping and releasing of the selector lever take place within a second and the selector lever is in the position “D” 5 in the automatic mode.

If the driver wishes to return again to the original program, for example the economy program, at a later time, he merely has to tip the selector lever 1 again to the left and release it again. The signals which are emitted by the sensor trigger the changing over into the original automatic program.

FIG. 2 shows a further embodiment of a shifting gate 4 both for the automatic mode and for the manual gear change mode with a sectioned selector lever 1. It comprises two shifting alleys 3 and 4. In the first shifting alley 3, the automatic shifting alley, the customary arrangement of the individual selector lever shifted positions for the assigned automatic transmission programs “P” 9, “R” 6, “N” 8, “D” 5 and the programs for limiting the maximum gear speed 7, for example for downhill travel “3”, “2”, “1” can be seen.

From the selector lever shifted position “D” 5, the selector lever 1 can be pivoted over into the second shifting alley 4 via a transverse alley 13 so that the selector lever is in the position 10 for the manual gear change. Manual gear changes can now be carried out by the driver, specifically by pushing the selector lever 1 forward into the position “+” 11, shifting up, and by pulling the selector lever 1 back into the position “−” 12, shifting down. Here too, the driving program can be switched over, for example from the economy program into the sport program during an overtaking process from the selector lever shifted position “D” 5 by tipping the selector lever 1 to the left and releasing it again.

Here, depending on the embodiment, the shifting process can be carried out by the driver tipping the selector lever 1 counter to a spring force and the selector lever 1 then springing back automatically into the selector lever shifted position “D” 5. Alternatively, the selector lever 1 is intentionally briefly moved by the driver into the position 10 for the manual gear change. The position is a latched position insofar as the selector lever 1 would latch into this position 10. In order to carry out the method, the selector lever 1 must, however be moved again back into the position “D” 5 by the driver within the time interval.

During the pivoting over of the selector lever 1 into the shifting alley 4, it is impossible for unintentional shifting into another driving program to occur since the control unit only triggers a changeover of driving program when the two signals when the selector lever 1 is tipped and released again occur within a time interval and the selector lever is in the position “D” 5 in the automatic mode.

### LIST OF REFERENCE NUMERALS

1 Selector lever
2 Center console
3 Shifting gate alley 1 for the automatic mode
4 Shifting gate alley 2 for the manual gear change
5 Selector lever position automatic travel mode forward
6 Selector lever position automatic travel mode backward
7 Selector lever positions automatic travel mode with limitation of maximum gear speed
8 Selector lever position idling
9 Selector lever position parking brake
10 Selector lever position travel mode manual gear change
11 Selector lever position travel mode manual gear change—shifting up
12 Selector lever position travel mode manual gear change—shifting down
13 Shifting gate transverse alley

I claim:

1. A method for selecting at least two different driving programs in a motor vehicle having an automatic transmission, in particular an economy program and a sport program, without operator controls other than an automatic transmission selector lever (1) in a gate (3), wherein the driving program is changed by lateral movement of the selector lever with respect to the gate, comprising the steps of:
generating corresponding signals upon successive lateral movements of the selector lever, and
changing from one of the at least two driving programs to another of the driving programs when a time interval between the corresponding signals is within a predefined range.

2. The method as claimed in claim 1, wherein, said predefined range is between 0.1 second and 2 seconds.

3. The method as claimed in claim 1, wherein at least two driving programs can be selected, a first driving program triggered by movement of the selector lever (1) to a first side of the gate, and a second driving program triggered by movement of the selector lever (1) to the other side of the gate.

4. The method as claimed in claim 1, wherein the number of lateral movements of the selector within the gate determines the driving program to be selected.

5. The method as claimed in claim 1, wherein the lateral movement is carried out by tipping the selector lever (1) counter to a spring force and releasing it again.

6. The method as claimed in claim 1, wherein the selector lever (1) is moved into a latched position lateral to a center longitudinal axis of the gate to activate one of the at least two driving programs.

7. The method as claimed in claim 6, wherein a first driving program is triggered by tipping the selector lever to a lateral position and a second driving program is triggered by movement of the selector lever into the latched position.

8. A device for selecting at least two different driving programs in motor vehicles having an automatic transmission, in particular an economy program and a sport program, without operator controls other than the automatic transmission selector lever, comprising
an automatic transmission selector lever (1) which is guided in a shifting gate (3),
an electric signal generator that generates electrical signals during a lateral movement of the selector lever (1) within the gate (3), and
a control device which triggers a driving program changeover when the time interval between the signals generated during a lateral movement of the selector drops below a defined value.

9. The device as claimed in claim 8, wherein a first signal for changing over the driving program is generated by tipping in the transverse direction laterally of a longitudinal axis of the gate, and a second signal is generated by releasing the selector lever (1) again counter to a spring force, the control unit not triggering a driving program changeover until the spring force exceeds a defined value,
the two signals occur with a defined time interval when the selector lever is tipped and released again, and
the selector lever is in an automatic mode (5).

10. The device as claimed in claim 8, wherein a first signal for changing the driving program is generated by laterally tipping the selector lever (1) counter to a spring force, and a second signal is generated upon releasing the selector, with the signals being generated by position sensors both when the selector lever leaves a position of rest along a longitudinal axis of the gate, and when it returns to said position of rest along said axis,
the control unit not triggering a change of the driving program until the pivot path of the selector lever exceeds a defined value,
the two signals occur with a predefined time interval when the selector lever is tipped and released again, and
the selector lever is in the automatic mode (5).

11. The device as claimed in claim 8, wherein a first signal for changing over the driving program is triggered by a lateral movement to a latching position and a second signal is generated by movement of the selector lever (1) back to a position along a longitudinal axis in the gate, the control unit not triggering a driving program changeover until the reaching of the latched position has been detected by a latch detector,
the lateral movement of the selector lever occurring within a predefined time interval, and
the selector lever is in the automatic mode (5).

12. The device as claimed in claim 8, wherein the shifting gate of the automatic transmission shifting device has a shifting gate alley in which the selector lever (1) can assume at least the shifted positions park (9), reverse (6), neutral (8) and drive (5).

13. The device as claimed in claim 8, wherein the shifting gate additionally has a shifting gate alley for a manual gear change mode, in which alley the selector lever (1) can assume positions for the manual gear change mode (10), for up shifting (11) and for down shifting (12).

14. The device as claimed in claim 13, wherein the shifting gate additionally has a shifting gate transverse alley (13) for changing between the shifting gate alley for the automatic mode and for the manual gear change mode.

15. The device as claimed in claim 8, wherein more than two driving programs can be selected when the selector lever (1) is moved laterally to the left and/or to the right.

16. The device as claimed in claim 8, wherein the device also comprises a display device and the respectively active driving program is displayed in this display device.

17. The device as claimed in claim 16, wherein the display device is arranged on the dashboard of a motor vehicle.
